(19) United States
(12) Patent Application Publication
(10) Pub. No.: US 2024/0167445 A1
(43) Pub. Date: May 23, 2024

(54) IGNITION DEVICE FOR INTERNAL COMBUSTION ENGINE

(71) Applicants: HYUNDAI MOTOR COMPANY, SEOUL (KR); KIA CORPORATION, SEOUL (KR)

(72) Inventors: Soo Hyung WOO, Seoul (KR); Ki Seon SIM, Suwon-si (KR)

(21) Appl. No.: 18/137,422

(22) Filed: Apr. 20, 2023

(30) Foreign Application Priority Data
Nov. 23, 2022 (KR) 10-2022-0158600

(51) Int. Cl. F02P 3/04; H01F 38/12

(52) U.S. Cl. CPC F02P 3/0414; H01F 38/12

(57) ABSTRACT

Enclosed is an ignition device for an internal combustion engine. The ignition device includes a coil unit including a plurality of coil modules each of which includes a primary coil and a secondary coil, a cable commonly connected to each of opposite ends of the secondary coils of each of the coil modules of the coil unit, spark plugs each of which is connected to the cable and installed in one of combustion chambers having the same phase, and a controller provided to sequentially switch power supplied from a power source to the primary coils of each coil module of the coil unit.

### CROSS-REFERENCE TO RELATED APPLICATION

This application is based on and claims priority under U.S.C. 119 to Korean Patent Application No. 10-2022-0158600, filed on Nov. 23, 2022, in the Korean Intellectual Property Office, the disclosure of which is herein incorporated by reference in its entirety.

### BACKGROUND

### 1. Field

The present disclosure relates to an ignition device for an internal combustion engine.

### 2. Description of the Prior Art

To improve the combustion of a gasoline engine, the continuity of arc formation of a spark plug in a cylinder be made over a certain period of time.

A technique of forming a continuous arc in a spark plug by alternately performing ignition by using dual coils has been developed, but there is a problem in that the number of coils increases.

It should be understood that the foregoing description of the background art is intended to enhance understanding of the background of the present disclosure, and should not be taken as an admission that the background art corresponds to prior art known to those ordinarily skilled in the art.

### SUMMARY

The present disclosure provides an ignition device for an internal combustion engine that is capable of improving a combustion characteristic of a gasoline engine at a relatively low cost by forming a continuous arc in a spark plug while including as few coils as possible.

In view of the foregoing, an ignition device for an internal combustion engine of the present disclosure includes a coil unit including a plurality of coil modules each of which includes a primary coil and a secondary coil, a cable commonly connected to each of opposite ends of the secondary coils of each of the coil modules of the coil unit, spark plugs each of which is connected to the cable and installed in one of combustion chambers having the same phase, and a controller provided to sequentially switch power supplied from a power source to the primary coils of each coil module of the coil unit.

Each of the primary coils of each coil module of the coil unit may have one end and the other end, which are connected to the power source and the controller, respectively.

The controller may be configured to alternately switch the power supplied from the power source to the primary coils of each of the coil modules of the coil unit with a time difference such that the arc generated by the spark plug is continuously formed by the power supplied to the primary coils of each of the coil modules of the coil unit.

The coil unit may include an A coil module and a B coil module, in which one of the spark plugs may be commonly connected to one end of the secondary coil of the A coil module and one end of the secondary coil of the B coil module.

A remaining one of the spark plugs may be commonly connected to the other end of the secondary coil of the A coil module and the other end of the secondary coil of the B coil module.

One end of the primary coil of the A coil module may be connected to the power source, and one end of the primary coil of the B coil module may be connected to the power supply.

The other end of the primary coil of the A coil module may be connected to the controller via an A switching element, and the other end of the primary coil of the B coil module may be connected to the controller through a B switching element.

The controller may be connected to drive the A switching element and the B switching element.

The controller may be configured to sequentially drive the A switching element and the B switching element, and drive the B switching element to continuously form an arc generated in the spark plugs before the arc generated in the spark plugs by driving the A switching element is extinguished.

The spark plugs commonly connected to each of the opposite ends of the secondary coils of the coil unit may be respectively installed in pairs in combustion chambers having the same crank phase angle of the internal combustion engine.

The spark plugs commonly connected to each of the opposite ends of the secondary coils of the coil unit may be installed in pairs in combustion chambers having the same crankpin center phase of the internal combustion engine.

In view of the foregoing, an ignition device for an internal combustion engine of the present disclosure may include a coil unit including a plurality of primary coils provided to generate an induced electromotive force in one secondary coil, spark plugs each of which is connected to opposite ends of the secondary coil, and a controller provided to sequentially switch power supplied from a power source to the primary coils of the coil unit.

Each of the primary coils of the coil unit may have one end and the other end, which are connected to the power source and the controller, respectively.

The coil unit may include two primary coils, one of which may be connected to the controller via an A switching element, and the remaining one of which may be connected to the controller via a B switching element, and the controller may be connected to drive the A switching element and the B switching element.

The controller may be configured to sequentially drive the switching element A and the switching element B, and drive the B switching element to continuously form an arc generated in the spark plugs before the arc generated in the spark plugs by driving the A switching element is extinguished.

The controller may be configured to alternately switch the power supplied from the power source to the primary coils of the coil unit with a time difference such that the arc generated by the spark plug is continuously formed by the power supplied to the primary coils of the coil unit.

The spark plugs commonly connected to each of the opposite ends of the secondary coils of the coil unit may be respectively installed in pairs in combustion chambers having the same crank phase angle of the internal combustion engine.

The spark plugs commonly connected to each of the opposite ends of the secondary coils of the coil unit may be respectively installed in pairs in two combustion chambers in which a compression stroke and an exhaust stroke of the internal combustion engine are simultaneously performed.

In addition, in view of the foregoing, an internal combustion engine of the present disclosure includes an ignition device configured as described above.

The present disclosure provides an ignition device for an internal combustion engine that is capable of improving a combustion characteristic of a gasoline engine at a relatively low cost by forming a continuous arc in a spark plug while including as few coils as possible.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating an ignition device for an internal combustion engine according to the present disclosure;

FIG. 2 is a view illustrating driving a spark plug according to the operation of the ignition device of FIG. 1;

FIG. 3 is a diagram illustrating a combustion chamber arrangement and ignition sequence of an internal combustion engine to which the present disclosure is applicable;

FIG. 4 is a diagram illustrating the order of strokes for each combustion chamber of the internal combustion engine illustrated in FIG. 3;

FIG. 5 is a view illustrating an example in which an ignition device according to the present disclosure is installed the an internal combustion engine illustrated in FIG. 3; and

FIG. 6 is a view illustrating another embodiment of an ignition device for an internal combustion engine according to the present disclosure.

### DETAILED DESCRIPTION

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

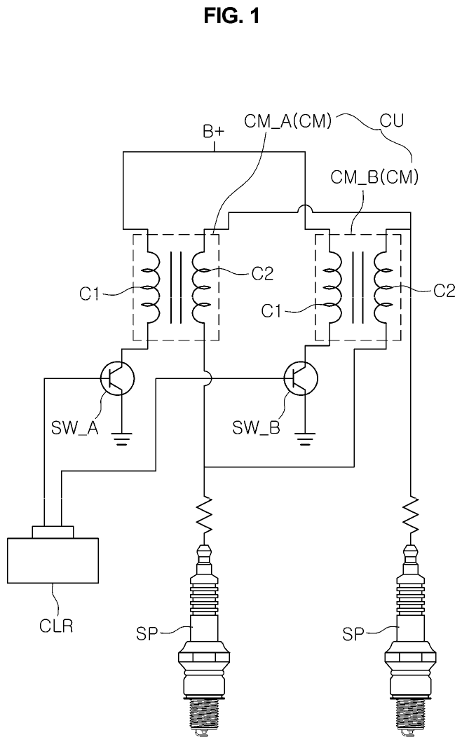

Referring to FIGS. 1 to 5, an embodiment of an ignition device for an internal combustion engine of the present disclosure includes a coil unit CU including a plurality of coil modules CM each of which includes a primary coil C1 and a secondary coil C2, a cable commonly connected to each of opposite ends of the secondary coils C2 of each coil module CM of the coil unit CU, spark plugs SP to each of which is connected to the cable and installed in one of combustion chambers having the same phase, and a controller CLR provided to sequentially switch power supplied to the primary coils C1 of each coil module CM of the coil unit CU.

That is, each coil module CM includes a primary coil C1 and a secondary coil C2, the coil unit CU includes a plurality of coil modules CM configured as described above, and the controller CLR is installed to sequentially supply power from a power source to the plurality of primary coils C1 included in the coil unit CU.

Each of the primary coils C1 of each coil module CM of the coil unit CU has one end and the other end, which are connected to the power source and the controller CLR, respectively.

For reference, in FIG. 1, the power source is indicated as B+ to indicate that a vehicle battery or the like is connected.

More specifically, the coil unit CU includes an A coil module CM_A and a B coil module CM_B, in which one of the spark plugs SP is commonly connected to one end of the secondary coil C2 of the A coil module CM_A and one end of the secondary coil C2 of the B coil module CM_B, and the remaining one of the spark plugs SP is commonly connected to the other end of the secondary coil C2 of the A coil module CM_A and the other end of the secondary coil C2 of the B coil module CM_B.

In addition, one end of the primary coil C1 of the A coil module CM_A is connected to the power source, one end of the primary coil C1 of the B coil module CM_B is connected to the power supply, the other end of the primary coil C1 of the A coil module CM_A is connected to the controller CLR via an A switching element SW_A, and the other end of the primary coil C1 of the B coil module CM_B is connected to the controller CLR via a B switching element SW_B.

Of course, the controller CLR may be connected to drive the A switching element SW_A and the B switching element SW_B, and may be configured as an engine control unit (ECU).

The controller CLR is configured to sequentially drive the A switching element SW_A and the B switching element SW_B and drive the B switching element SW_B to continuously form an arc in the spark plugs SP before the arc generated in the spark plugs SP by driving the A switching element SW_A is extinguished.

That is, the controller CLR is configured to alternately switch power supplied from the power source to the primary coils C1 of respective coil modules CM of the coil unit CU with a time difference such that the arc generated in the spark plugs S are continuously formed by the power supplied to the primary coils C1 of respective coil modules CM of the coil unit CU.

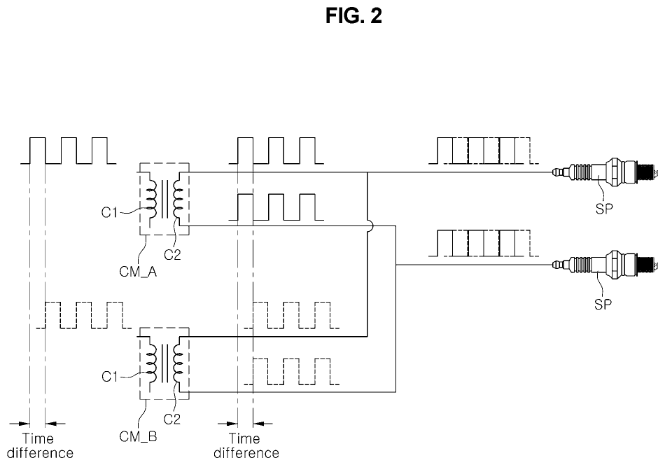

For example, as illustrated in FIG. 2, when the controller CLR causes a switching pulse supplied to the primary coil C1 of the B coil module CM_B to be supplied later than a switching pulse supplied to the primary coil C1 of the A coil module CM_A by the illustrated predetermined “time difference,” in the two spark plugs SP connected to the secondary coil C2, an induced electromotive force induced to the secondary coil C2 by the electricity supplied to the primary coil C1 of the A coil module CM_A and an induced electromotive force induced to the secondary coil C2 by the electricity supplied to the primary coil C1 of the B coil module CM_B are sequentially combined, and thus it is possible to substantially continuously supply secondary current to the spark plugs SP, whereby a continuous arc is formed in the spark plugs SP.

As described above, when the spark plugs SP form a continuous arc, more easy and reliable combustion of a mixture gas occurs in the combustion chambers, whereby it is possible to improve the output and fuel economy of the internal combustion engine.

The spark plugs SP, which are commonly connected to each of the opposite ends of the secondary coils C2 of the coil unit CU, are installed in pairs in combustion chambers having the same crank phase angle of the internal combustion engine.

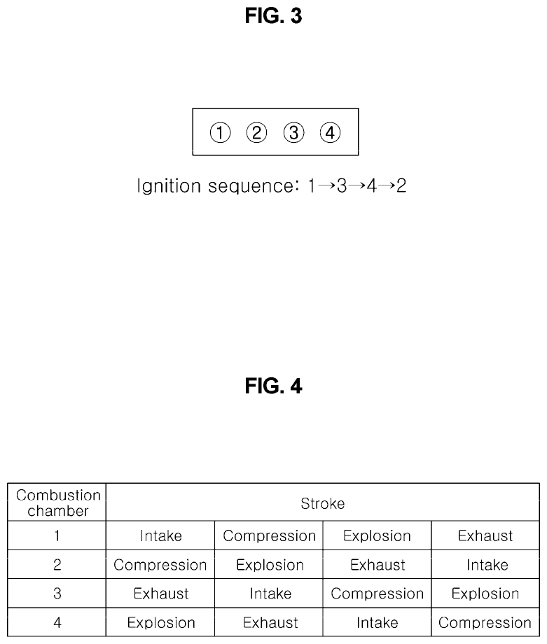

An internal combustion engine E having the combustion chamber arrangement and ignition sequence as illustrated in FIG. 3 has a 4-stroke sequence as summarized in FIG. 4 for each combustion chamber. Since the first combustion chamber and the fourth combustion chamber have the same crank phase angle, when one combustion chamber performs a compression stroke, the other combustion chamber performs an exhaust stroke. Meanwhile, since the second combustion chamber and the third combustion chamber also have the same crank phase angle, when one combustion chamber performs a compression stroke, the other combustion chamber performs an exhaust stroke.

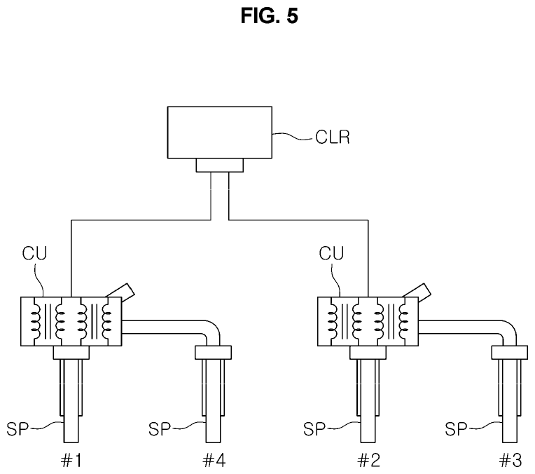

FIG. 5 illustrates an example in which an ignition device according to the present disclosure is installed in an internal combustion engine E configured and operated as described above with reference to FIGS. 3 and 4. The figure illustrates that two spark plugs SP connected to the left coil unit CU are installed in the first combustion chamber and the fourth combustion chamber, respectively, and two spark plugs SP connected to the right coil unit CU are installed in the second combustion chamber and the third combustion chamber, respectively.

That is, the spark plugs SP commonly connected to each of the opposite ends of the secondary coils C2 of the left coil unit CU are installed in the first combustion chamber and the fourth combustion chamber, respectively, having the same crank phase angle. The spark plugs SP commonly connected to each of the opposite ends of the secondary coils C2 of the right coil unit CU are respectively installed in the second combustion chamber and the third combustion chamber having the same crank phase angle.

In addition, in FIG. 5, the controller CLR is configured to control both the left coil unit CU and the right coil unit CU.

For reference, #1, #2, #3, and #4 on the lower side of respective spark plugs SP indicate that the corresponding spark plugs SP are installed in the first combustion chamber, the second combustion chamber, the third combustion chamber, and the fourth combustion chamber, respectively.

Therefore, when the controller CLR sequentially drives the two primary coils C1 of the left coil unit CU at the end of the compression stroke of the first combustion chamber, the spark plug SP installed in the first combustion chamber and the spark plug SP installed in the fourth combustion chamber form an arc at the same time. As a result, the first combustion chamber ignites the mixture gas to smoothly perform the explosion stroke, and since the combustion chamber 4 is in the exhaust stroke, the arc of the spark plug SP becomes an invalid discharge.

At this time, since the spark plugs SP of the first combustion chamber and the fourth combustion chamber sequentially drive the two primary coils C1 of the left coil unit CU, an arc is continuously formed to be longer than that formed in the case where only one primary coil C1 is driven. Thus, it is possible to make the ignition of the mixture gas in the combustion chamber 1 very stably and effectively, contributing to the improvement of the output and fuel economy of the internal combustion engine.

The relationship between the right coil unit CU and the spark plugs SP installed in the remaining second combustion chamber and third combustion chamber is the same as the relationship between the left coil unit CU and the spark plugs SP installed in the first combustion chamber and the fourth combustion chamber.

As described above, the spark plugs SP, which are commonly connected to each of the opposite ends of the secondary coils C2 of the coil units CU may be expressed as being installed in two combustion chambers, respectively, in which the compression stroke and the exhaust stroke of the internal combustion engine (E) are performed simultaneously, may be expressed as being installed in two combustion chambers, respectively, in which the intake stroke and the explosion stroke of the internal combustion engine are performed simultaneously, and may be expressed as being installed in pairs in the combustion chambers which have the same crankpin center phase of the internal combustion engine E.

For reference, an example in which the ignition device according to the present disclosure is installed in an in-line 4-cylinder internal combustion engine has been described above. The ignition device of the present disclosure may be installed according to the technical concept described above, not only in an in-line 6-cylinder internal combustion engine, but also in an internal combustion engine including multiple combustion chambers, such as a V-type 6-cylinder internal combustion engine or a V-type 8-cylinder internal combustion engine.

As described above, compared to a so-called “single coil single ignition” internal combustion engine in which coil modules including a primary coil and a secondary coil are individually disposed in each combustion chamber, while using the same number of coils, the ignition device for an internal combustion engine according to the present disclosure allows a continuous arc to be generated in the spark plugs in the combustion chambers for a relatively long time close to twice that in the single coil single ignition internal combustion engine, thereby greatly improving the ignition reliability and efficiency of the mixture gas.

Compared to a conventional so-called “dual coil multi-stage ignition” internal combustion engine in which two coil modules, each of which includes a primary coil and a secondary coil, are provided for each combustion chamber so that a continuous arc can be generated in the spark plug, the internal combustion engine using the ignition device according to the present disclosure makes it possible to relatively reduce the number of coils by half.

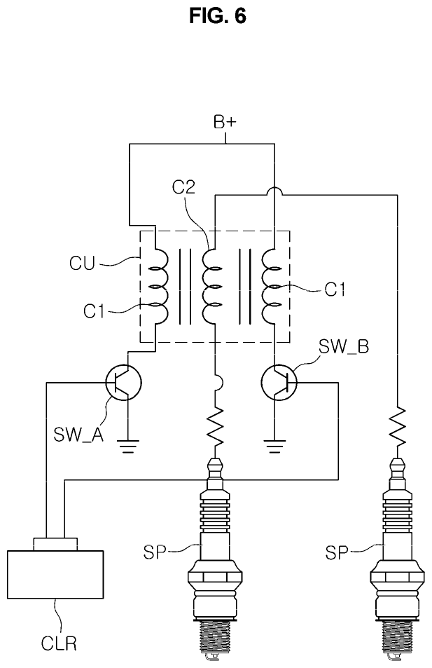

Referring to FIG. 6, another embodiment of the ignition device for an internal combustion engine according to the present disclosure includes a coil unit CU including a plurality of primary coils C1 provided to generate an induced electromotive force in one secondary coil C2, spark plugs SP connected to each of opposite ends of the secondary coil C2, and a controller CLR provided to sequentially switch power supplied from a power source to the primary coils C1 of the coil unit CU.

That is, the other configuration of this embodiment is the same as that of the embodiment of FIG. 1, except that the coil unit CU includes only one secondary coil C2.

Each of the primary coils C1 of the coil unit CU has one end and the other end, which are connected to the power source and the controller CLR, respectively.

In this embodiment, the coil units CU includes two primary coils C1, one of which is connected to the controller CLR via an A switching element SW_A and the remaining one of which is connected to the controller CLR via a B switching element SW_B, and the controller CLR is connected to drive the A switching element SW_A and the B switching element SW_B.

The controller CLR may be configured to sequentially drive the A switching element SW_A and the B switching element SW_B, and drive the B switching element SW_B to continuously form an arc in the spark plugs SP before the arc generated in the spark plugs SP by driving the A switching element SW_A is extinguished.

That is, the controller CLR is configured to alternately switch power supplied from the power source to the primary coils C1 of the coil unit CU with a time difference such that the arc generated by the spark plug SP is continuously formed by the power supplied to the primary coils C1 of the coil unit CU.

The spark plugs SP, which are commonly connected to each of opposite ends of the secondary coils C2 of the coil unit CU are respectively installed in pairs in combustion chambers having the same crank phase angle of the internal combustion engine.

The spark plugs SP, which are commonly connected to each of the opposite ends of the secondary coils C2 of the coil unit CU, are respectively installed in pairs in combustion chambers in which the compression stroke and the exhaust stroke of the internal combustion engine are performed at the same time.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. An ignition device for an internal combustion engine, the ignition device comprising:
a coil unit comprising a plurality of coil modules each of which comprises a primary coil and a secondary coil;
a cable commonly connected to each of opposite ends of the secondary coils of each of the plurality of coil modules of the coil unit;
a plurality of spark plugs, wherein each spark plug of the plurality of spark plugs is connected to the cable and installed in one of a plurality of combustion chambers having a same phase; and
a controller provided to sequentially switch power supplied from a power source to the primary coil of each coil module of the coil unit.

2. The ignition device of claim 1, wherein the primary coil of each of the plurality of coil modules of the coil unit has one end and another end, which are connected to the power source and the controller, respectively.

3. The ignition device of claim 1, wherein the controller is configured to alternately switch the power supplied from the power source to the primary coils of each of the coil modules of the coil unit with a time difference such that the arc generated by the spark plug is continuously formed by the power supplied to the primary coils of each of the coil modules of the coil unit.

4. The ignition device of claim 1, wherein the coil unit comprises an A coil module and a B coil module,
one of the plurality of spark plugs is commonly connected to one end of the secondary coil of the A coil module and one end of the secondary coil of the B coil module, and
a remaining one of the plurality of spark plugs is commonly connected to another end of the secondary coil of the A coil module and another end of the secondary coil of the B coil module.

5. The ignition device of claim 4, wherein one end of the primary coil of the A coil module is connected to the power source,
one end of the primary coil of the B coil module is connected to the power source,
another end of the primary coil of the A coil module is connected to the controller via an A switching element,
another end of the primary coil of the B coil module is connected to the controller via a B switching element, and
the controller is connected to drive the A switching element and the B switching element.

6. The ignition device of claim 5, wherein the controller is configured to:
sequentially drive the switching element A and the switching element B; and
drive the B switching element to continuously form an arc generated in the spark plugs before the arc generated in the plurality of spark plugs by driving the A switching element is extinguished.

7. The ignition device of claim 1, wherein the plurality of spark plugs commonly connected to each of the opposite ends of the secondary coils of the coil unit are respectively installed in pairs in combustion chambers having a same crank phase angle of the internal combustion engine.

8. The ignition device of claim 1, wherein the plurality of spark plugs commonly connected to each of opposite ends of the secondary coils of the coil unit are installed in pairs in combustion chambers having a same crankpin center phase of the internal combustion engine.

9. An ignition device for an internal combustion engine, the ignition device comprising:
a coil unit comprising a plurality of primary coils provided to generate an induced electromotive force in one secondary coil;
a plurality of spark plugs each of which is connected to opposite ends of the secondary coil; and
a controller provided to sequentially switch power supplied from a power source to the plurality of primary coils of the coil unit.

10. The ignition device of claim 9, wherein each of the plurality of primary coils of the coil unit has one end and another end which are connected to the power source and to the controller, respectively.

11. The ignition device of claim 10, wherein the coil unit comprises two primary coils, wherein a first primary coil of the two primary coils is connected to the controller via an A switching element, and a second primary coil of the two primary coils is connected to the controller via a B switching element, and
the controller is connected to drive the A switching element and the B switching element.

12. The ignition device of claim 11, wherein the controller is configured to:
sequentially drive the switching element A and the switching element B; and
drive the B switching element to continuously form an arc generated in the plurality of spark plugs before the arc generated in the plurality of spark plugs by driving the A switching element is extinguished.

13. The ignition device of claim 9, wherein the controller is configured to alternately switch the power supplied from the power source to the plurality of primary coils of the coil unit with a time difference such that the arc generated by the spark plug is continuously formed by the power supplied to the primary coils of the coil unit.

14. The ignition device of claim 9, wherein the plurality of spark plugs commonly connected to each of the opposite ends of the secondary coils of the coil unit are installed in pairs in combustion chambers having a same crank phase angle of the internal combustion engine.

15. The ignition device of claim 1, wherein the plurality of spark plugs commonly connected to each of the opposite ends of the secondary coils of the coil unit are respectively installed in pairs in combustion chambers in which a compression stroke and an exhaust stroke of the internal combustion engine are simultaneously performed.

16. An internal combustion engine comprising the ignition device of claim 1.
